(19) United States
(12) Patent Application Publication
(10) Pub. No.: US 2025/0297132 A1
(43) Pub. Date: Sep. 25, 2025

(54) CURABLE COMPOSITION FOR SEALING PROTRUSIONS THROUGH PREAPPLIED WATERPROOFING SYSTEMS

(71) Applicant: GCP Applied Technologies Inc., Malvern, PA (US)

(72) Inventors: Esra ALTINOK, Arlington, MA (US); Xia CAO, Acton, MA (US); Zichao WEI, Brighton, MA (US)

(21) Appl. No.: 19/090,084

(22) Filed: Mar. 25, 2025

Related U.S. Application Data
(60) Provisional application No. 63/569,489, filed on Mar. 25, 2024.

(51) Int. Cl. C09D 183/12; C08J 9/36; C09D 5/02; C09D 7/61; C09D 7/65; C09D 193/04

(52) U.S. Cl. CPC C09D 183/12; C08J 9/365; C09D 5/022; C09D 7/61; C09D 7/65; C09D 193/04

(57) ABSTRACT

A waterproofing curable composition, method of use, and building product containing such composition is provided. The curable composition, upon cure, exhibits strong adhesion to the construction substrates on which it is applied as well as to concrete cast upon the cured membrane, producing a continuous and fully bonded waterproof system, even though different surfaces and surface textures are presented at the surface-to-surface joinder among various components within a pre-applied waterproofing construction site.

### CROSS-REFERENCE TO RELATED APPLICATION(S)

This application claims priority under 35 U.S.C. § 119(e) to U.S. Provisional Application No. 63/569,489, entitled “CURABLE COMPOSITION FOR SEALING PROTRUSIONS THROUGH PREAPPLIED WATERPROOFING SYSTEMS,” by Esra ALTINOK et al., filed Mar. 25, 2024, which is assigned to the current assignee hereof and incorporated herein by reference in its entirety.

### FIELD OF THE INVENTION

The present invention relates to waterproofing compositions, systems, and methods in building and construction and, more particularly, to achieving tight waterproof bonds with various material surfaces such as concrete, synthetic polymer-containing membranes, and metals in soil retention assemblies having waterproofing membranes with penetrations due to pipes, steel rebar, rock anchors, and other detailing articles which present various surface-to-surface jointing or seaming challenges at a pre-applied waterproofing construction job site.

### BACKGROUND OF THE INVENTION

Pre-applied waterproofing, sometimes called “blind-side” or “reverse tanking” waterproofing, refers to an established practice in which first a membrane is positioned against a substrate, such as horizontal or vertical formwork or “lagging,” with a concrete freshly poured (i.e. “post-cast”) against the membrane to form a building structure (e.g., a foundation) or a civil engineering structure (e.g., tunnel). In other words, waterproofing is installed first, and building is “cast” afterward.

U.S. Pat. No. 5,496,615 of Bartlett et al. discloses a pre-applied waterproofing membrane having a carrier layer (e.g., polymer film), a pressure-sensitive adhesive layer (e.g., non-bituminous), and a protective coating (e.g., dusted particulate layer), against which concrete is “post-cast” to achieve a waterproof bond when cured. In contrast to conventional “post-applied” membranes that are adhered to existing structures, pre-applied waterproofing membranes enable the concrete to be cast and waterproofed in the same operation in relatively tight spaces, such as in urban areas where one building structure might be constructed against another structure.

However, it is necessary to achieve waterproof bonding with post-cast concrete at overlaps and seams between adjacent membranes, as well as across concrete joints; and continuity of a waterproofing barrier is a major objective when sealing around penetrations due to metal pipes, steel rebar, rock anchors, tiebacks, and other plastic or metal objects which present varied surface textures and materials.

In U.S. Pat. No. 8,475,909, Seth et al. disclosed pre-applied waterproofing membranes having three-dimensional, shaped contours useful for reverse-tanking waterproofing of detail areas such as those presented by tiebacks, pipes, pile caps, and other irregularities on concrete formworks. Tiebacks are large assemblies that secure the end of a rod, cable, or screw through waterproofing membrane and formwork to the soil or other adjacent structure against which the formwork is secured. The contoured membranes of Seth et al. were made of polymers that could be thermoformed to have shapes suitable for tiebacks (e.g., domed) or pipes (e.g., cylindrical) or other protrusions, and could employ waterproofing adhesives and protecting coatings similar to those used in the sheet-form membranes disclosed in U.S. Pat. No. 5,496,615 discussed above (See e.g., column 6, lines 17 et seq.). Various pre-applied membranes can be seamed together to provide a coherent waterproofing barrier despite penetrations caused by pipes, tiebacks, and other structures, and two-sided reverse tanking tape could be used to seam membrane components together. Such membranes and two-sided reverse tanking tapes are available from GCP Applied Technologies Inc. (Pennsylvania) under the PREPRUFE® brand name.

Liquid applied compositions for dealing with penetration issues would appear to be preferred over tapes and membranes for reasons of speed and convenience, and some have been mentioned in the patent literature concerning pre-applied waterproofing applications. For example, U.S. Publication No. 20120198787A1 describes a method wherein a liquid waterproofing material is sprayed onto backing material which is said to avoid seams that otherwise might be caused by sheet membrane installation that is followed by subsequent application of an adhesion promoting layer. U.S. Publication No. 20200199840A1 describes application of a liquid membrane having a purported greater adhesion to post-cast concrete as compared to adhesion to the lagging wall. U.S. Publication No. 20130059082A1 describes two-part construction sealant compositions that could be cured upon application.

Although liquid compositions have been described in the literature and offered by almost all major pre-applied waterproofing product manufacturers, the present inventors believe that there remains an unmet need for a novel liquid curable composition that can provide excellent bonding with various materials and their surfaces at penetration points: such as concrete surfaces (e.g., the post-cast concrete as well as pre-existing concrete of adjacent walls or structures), metal surfaces (e.g., pipes, steel reinforcing bars, fasteners, screws, etc.), and synthetic polymers (e.g., plastic or polymer carrier sheets of membranes or waterproofing meshes or fleeces). The liquid curable composition needs to exhibit excellent adhesion to these various substances, not only to fill in the cavities and niches of the penetration point and surface irregularities, but also to bond strongly with all of these materials so that a continuous and fully bonded waterproofing system is established with the post-cast concrete, whereby leaks are prevented.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act, or item of knowledge is referred to or discussed, this reference or discussion is not an admission that the document, act, or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### SUMMARY OF THE INVENTION

The long-standing but heretofore unfulfilled need for an improved liquid curable composition for below-grade pre-applied waterproofing is now met by a new, useful, and nonobvious invention.

In one aspect, disclosed herein is a curable composition including: at least one silane-modified polymer; and at least one of: (i) a latex emulsion with total organic solid in an amount of 5-90 wt % based on the total weight of the curable composition, (ii) a tackifier in an amount of at least 1 wt %, (iii) a polymeric additive, or (iv) a combination thereof, wherein the amounts in wt % are based on the total weight of the curable composition.

In yet another aspect, a method of waterproofing a construction surface is provided. The method includes: a. applying a liquid layer of the curable composition, as disclosed hereinabove, over the construction surface; and b. allowing the curable composition to cure, to form a solid waterproofing layer.

In another aspect, a waterproofing kit is provided. The waterproofing kit includes a first composition including at least one silane-modified polymer; and optionally a second composition including at least one latex emulsion with total organic solid in an amount of 5-90 wt %, wherein the first composition and/or the second composition comprise at least one tackifier, a polymeric additive, or combination thereof in an amount of at least 1 wt %, and wherein the amounts in weight % are based on the total weight of the curable composition.

In yet another aspect, disclosed herein is a waterproofing article including a waterproofing layer disposed over at least a portion of a functional layer, wherein the waterproofing layer is formed of the cured curable composition as disclosed hereinabove, and wherein the functional layer can be a barrier layer configured to provide moisture and/or vapor barrier.

The embodiments of the invention can be used alone or in combination with each other.

### BRIEF DESCRIPTION OF THE DRAWINGS

A greater appreciation of the benefits and features of the present invention may be more readily comprehended when the following written description of exemplary embodiments is considered in conjunction with the drawings, wherein:

FIG. 1 is a diagrammatic illustration of an exemplary method and system of the invention wherein a curable composition of the present invention is applied to a penetration in a waterproofing membrane installed on a construction substrate, such as a lagging formwork.

FIG. 2 is a schematic illustration of a cross-sectional view of an exemplary waterproofing article according to embodiments of the present invention.

FIG. 3 is a schematic illustration of a cross-sectional view of another exemplary waterproofing article according to embodiments of the present invention.

### DETAILED DESCRIPTION OF EXEMPLARY EMBODIMENTS

In the following detailed description of the preferred embodiments, reference is made to the accompanying drawings, which form a part thereof, and within which are shown by way of illustration specific embodiments by which the invention may be practiced. It is to be understood that other embodiments may be utilized, and structural changes may be made without departing from the scope of the invention.

The waterproofing curable compositions described herein are intended to bond with a variety of construction surfaces, such as new and/or fresh cementitious compositions that are cast against them and allowed to harden. Cementitious compositions, such as concrete or mortar cement, which are applied this way to the waterproofing membranes, are sometimes referred to as being “post cast” or “pre-applied waterproofing membrane.”

The terms “cement” and “cementitious composition” are used to refer to dry powders as well as to pastes, mortars, grouts, and concrete compositions comprising a hydratable cement binder. The terms “paste”, “mortar” and “concrete” are terms of art: pastes are mixtures composed of a hydratable cement binder (usually, but not exclusively, Portland cement, masonry cement, or mortar cement). Mortars are pastes additionally including fine aggregate (e.g., sand), and concrete are mortars additionally including coarse aggregate (e.g., crushed gravel, stone). Cementitious compositions are typically formed by mixing hydratable cement, water, and fine and/or coarse aggregate.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

As used herein, “about” means approximately or nearly and in the context of a numerical value or range set forth means ±15% of the numerical. In exemplary embodiments, the term “about” can include traditional rounding according to significant figures of the numerical value. In addition, the phrase “about ‘x’ to ‘y’” includes “about ‘x’ to about ‘y’”.

Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited.

For example, whenever a numerical range with a lower limit, RL, and an upper limit RU, is disclosed, any number R falling within the range is specifically disclosed. In particular, the following numbers R within the range are specifically disclosed: R=RL+k (RU−RL), where k is a variable ranging from 1% to 100% with a 1% increment, e.g., k is 1%, 2%, 3%, 4%, 5% . . . 50%, 51%, 52% . . . 95%, 96%, 97%, 98%, 99%, or 100%. Moreover, any numerical range represented by any two values of R, as calculated above, is also specifically disclosed.

Disclosed herein is a curable composition that includes: at least one silane-modified polymer, and at least one component selected from at least one latex emulsion, at least one tackifier, a polymeric additive, or a combination thereof. In an embodiment, the curable composition includes the at least one silane-modified polymer in an amount of 10-95 wt % based on the total weight of the curable composition and at least one latex emulsion with total organic solid in an amount of 5-90 wt % based on the total weight of the curable composition. In another embodiment, the curable composition includes at least one silane-modified polymer in an amount of 5-99 wt % based on the total weight of the curable composition; and at least one tackifier in an amount of at least 1 wt % based on the total weight of the curable composition.

At least one silane-modified polymer is used to make the curable composition. As used herein, the term “silane-modified polymer” refers to a polymer that includes a hydrolysable silyl group (i.e. chemical group that includes a silicon-alkoxy bond) that is attached to a polymer backbone, such as on a lateral site of the polymer backbone, on an end of the polymer backbone, or a combination thereof. For instance, the silane-modified polymer may include a silane-terminated polymer, which refers to a polymer terminating with a hydrolysable silyl group. Any silane-terminated polymer is envisioned. In an embodiment, the at least one silane-terminated polymer includes a silane-terminated polyether, an acrylic modified silane-terminated polyether, a silane-terminated polyacrylate, a silane-terminated polyolefin, a silane-terminated polyurethane, a silane-terminated polyester, a silane-terminated epoxy, or any combination thereof. In an embodiment, a hydrolysable silyl group can be attached to the end of the polymer backbone or a lateral site of the polymer backbone via an alkylene that can be, for example, either a methylene (alpha) or a propylene group (gamma). The silane may include any number of functionalities and include a monoalkoxy silane, a dialkoxy silane, a trialkoxy silane, or any combination thereof. Any number of carbon groups is envisioned for the alkoxy group and includes, for example, a C1-C6 carbon group. In an embodiment, the alkoxy group is a methoxy group, an ethoxy group, or any combination thereof. In an embodiment, a silane-modified polymer with a lateral silane is envisioned. In such case, the polymer backbone can include, for example, a polyester, a polyether, a polycarbonate, a polycaprolactone, polybutadiene, the like, or any combination thereof. In a particular embodiment, the at least one silane-modified polymer is a silane-terminated polyether polymer. In an embodiment, the at least one silane-modified polymer includes at least two silane-terminated polyether polymers. When at least two silane-modified polymers are used, they may be the same or different silane-modified polymers by way of polymer backbone, functional group, molecular weight, glass transition temperature, and/or hydrophobicity.

Any amount of the at least one silane-modified polymer is envisioned and is dependent on the properties desired for the curable composition. For instance, the curable composition may be based on a “two-component system” that includes, but is not limited to, to at least one silane modified polymer and at least one latex emulsion. When a two-component system is utilized, the at least one silane-modified polymer is present in an amount of 10-95 wt % based on the total weight of the curable composition and the at least one latex emulsion is present with total organic solid in an amount of 5-90 wt % based on the total weight of the curable composition. In an embodiment, the amount of the at least one silane-modified polymer is at least 15 wt %, or at least 20 wt %, or at least 25 wt %, or at least 30 wt %, or at least 35 wt %, or at least 40 wt %, or at least 45 wt %, based on the total weight of the curable composition. In another embodiment, the curable composition may be based on a “one-component system” that includes, but is not limited, to the least one silane-modified polymer, and the at least one tackifier, a polymeric additive, or combination thereof. When a one-component system is utilized, the at least one silane-modified polymer is present in an amount of 5-99 wt % based on the total weight of the curable composition and the at least one tackifier is present in an amount of at least 1 wt % based on the total weight of the curable composition. For instance, the amount of the at least one silane-modified polymer is at least 10 wt %, or at least 15 wt %, or at least 20 wt %, or at least 25 wt %, or at least 30 wt %, or at least 35 wt %, or at least 40 wt %, or even at least 45 wt %, based on the total weight of the curable composition. In an embodiment and irrespective of the one-component or two-component system, the amount of the at least one silane-modified polymer is not greater than 50 wt %, or not greater than 45 wt %, or not greater than 40 wt %, or even not greater than 35 wt %, based on the total weight of the curable composition. In an embodiment, the amount of the at least one silane-modified polymer is not greater than 90 wt %, or not greater than 85 wt %, or not greater than 80 wt %, or not greater than 75 wt %, or not greater than 70 wt %, or not greater than 65 wt %, or not greater than 60 wt %, or not greater than 55 wt %, or based on the total weight of the curable composition.

In an embodiment, the silane-modified polymer may have advantageous properties. Advantageous properties may include, desired viscosity for easy application; control of curing rate at different temperatures; a material that is free of isocyanates, solvents, and/or tin catalyst; or any combination thereof. In an embodiment, the viscosity of the at least one silane-modified polymer of the present invention is typically 0.1 mPa·s to 70,000 mPa·s, more typically 1000 mPa·s to 50000 mPa·s, even typically 7000 mPa·s to 42000 mPa·s measured according to ASTM D4889-21(2021), Method A. In the case where the viscosity is greater than 70,000 mPa·s, a curable composition has a high viscosity, lowered workability, and could have undesirable curing in some cases.

The curable composition may include at least one latex emulsion. Any latex emulsion is envisioned and includes a stable dispersion of polymer particles in water. The polymer particles present in the at least one latex emulsion include at least one homopolymer and/or copolymer. In an embodiment, the polymer particles have a core-shell structure, wherein each of the core and shell comprises a different polymer, either a homopolymer or a copolymer including, but not limited to, an acrylate, a styrene acrylate, a silane, a siloxane, a polyvinyl, a carboxylated styrene butadiene, a styrene butadiene, a styrene isoprene, or any combination thereof. When present, any amount of the at least one latex emulsion is envisioned. For instance, the at least one latex emulsion with total organic solid, primarily due to the polymer particles, may be present in an amount of 5-90 weight % based on the total weight of the curable composition. For instance, the amount of the latex emulsion is at least 10 wt %, or at least 15 wt %, or at least 20 wt %, or at least 25 wt %, or at least 30 wt %, or at least 35 wt %, or at least 40 wt %, or at least 45 wt %, or at least 50 wt %, or at least 55 wt %, or at least 60 wt %, or at least 65 wt %, or at least 70 wt %, based on the total weight of the curable composition. Further, the amount of the latex emulsion is not greater than 85 wt %, or not greater than 80 wt %, or not greater than 75 wt %, or not greater than 70 wt %, or not greater than 65 wt %, or not greater than 60 wt %, or not greater than 55 wt %, based on the total weight of the curable composition.

Further included in the curable composition may be at least one tackifier. Within the context of the present disclosure, the term “tackifier” refers to a compound that is incorporated into the composition and increases tack of the cured membrane. Any tackifier is envisioned that is miscible in the silane-modified polymer and provides desirable adhesion to post-cast concrete. In a particular embodiment, the tackifier is soluble at room temperature. Suitable tackifiers include, but are not limited to, a hydrogenated gum rosin, a glycerol ester of gum rosin, a pentaerythritol ester of gum rosin, a methyl ester of gum rosin, an aromatic hydrocarbon resin, an aliphatic hydrocarbon resin, a mixed aliphatic/aromatic resin, a terpene resin, a hydrogenated hydrocarbon resin, an alkylphenol resin, a modified phenol-formaldehyde resin, or any combination thereof. In an embodiment, the hydrocarbon resin includes, but is not limited to, a C1-C12 aliphatic resin, a C1-C12 aromatic resin, a C1-C12 copolymer resin, and the like. In a particular embodiment, the tackifier includes the hydrogenated gum rosin.

Any amount of tackifier is envisioned and is dependent on the properties desired for the curable composition. For instance and when present, the at least one tackifier may be present in an amount of at least 5 wt %, or at least 10 wt %, at least 15 wt %, or at least 20 wt %, or at least 25 wt %, or at least 30 wt %, based on the total weight of the curable composition. In an embodiment, the amount of the at least one tackifier is not greater than 95 wt %, or not greater than 90 wt %, or not greater than 85 wt %, or not greater than 80 wt %, or not greater than 75 wt %, or not greater than 70 wt %, or not greater than 65 wt %, or not greater than 60 wt %, or not greater than 55 wt %, or not greater than 50 wt %, or not greater than 40 wt %, or not greater than 35 wt %, or not greater than 30 wt %, or not greater than 25 wt %, based on the total weight of the curable composition.

In an embodiment, a polymeric additive(s) may be added to the curable composition. As used herein, the polymeric additive may include polymer particles, polymer powders, liquid rubbers, or any combination thereof. The polymer particles and powders may have any suitable size, such as an average particle size in the range of 50 nm to 500 microns, as measured by light scattering. Suitable polymer powders or polymer particles may include, but are not limited to, vinyl acetate-based copolymers (such as vinyl acetate-ethylene (VAE) copolymer, vinyl-acetate-versatate (VeoVa) copolymer), styrenic copolymers (such as, styrenic-butadiene (SB) copolymer, styrene-isoprene-styrene (SIS) copolymer, styrene-acrylate (SA)), polyolefin (such as polyethylene (PE), polypropylene (PP)), polytetrafluoroethylene (PTFE), polyamide (PA) epoxy, polyurethane, phenolic resin, acrylate (such as polymethyl methacrylate (PMMA)), carboxylate, and the like. Liquid rubbers include but are not limited to liquid polybutadiene rubber, liquid polyisoprene rubber, liquid polystyrene/butadiene rubber, liquid silicone rubber, liquid polyurethane rubber, and the like. Any amount of polymeric additive is envisioned and when present includes, for example, an amount of at least 0.3 wt %, or at least 0.5 wt %, or at least 0.8 wt %, or at least 1.0 wt. %, or even at least 1.5 wt %, based on the total weight of the curable composition. In an embodiment, an amount of the polymeric additive is not greater than 50 wt %, or not greater than 45 wt %, or not greater than 40 wt %, or not greater than 35 wt %, or not greater than 30 wt %, or not greater than 25 wt. %, or not greater than 20 wt. %, or not greater than 15 wt. %, or not greater than 10 wt. %, or not greater than 7.5 wt. %, or not greater than 5 wt. %, or even not greater than 3.0 wt. %, based on the total weight of the curable composition.

The curable composition may further include any additive envisioned, depending on the final properties desired. In an embodiment, the additive includes a filler. Any filler is envisioned. In an embodiment, the filler includes, but is not limited to, calcium carbonate, talc, amorphous silica, magnesium silicate, mica, graphite, white cement, fly ash, titanium oxide, silica fume, bentonite, or any combination thereof. Any amount is envisioned and depends on the final properties desired for the cured composition. In an embodiment, the at least one filler is present at an amount of at least 20 wt %, or at least 25 wt %, or at least 30 wt %, or at least 35 wt %, based on the total weight of the curable composition. In an embodiment, the at least one filler is present at an amount of not greater than 50 wt %, or not greater than 45 wt %, or not greater than 40 wt %, or not greater than 35 wt %, or not greater than 30 wt %, based on the total weight of the curable composition.

Further additives include a dispersant, a light stabilizer, a UV absorber, a pigment, an antioxidant, an adhesion promoter, a moisture scavenger, a defoamer, a rheology modifier, a catalyst, a plasticizer, a wax, a reactive diluent, the like, or any combination thereof. A dispersant is an additive used to aid in the dispersing properties of the components of the curable composition. An exemplary dispersant includes, for example, a low molecular weight polymer, a high molecular weight polymer, an oligomer with an anionic functional group, an oligomer with a cationic functional group, an oligomer with a nonionic functional group, or any combination thereof. The dispersant may be chosen to incorporate materials into the curable composition such as, for example, a polyacrylate, a polyether, a polyurethane, a polyester, a polycarboxylate, a polyglycol, fatty acid chemistry (FAME), the like, or any combination thereof. In an embodiment, the at least one dispersant is present at an amount of not greater than 6.0 wt %, or not greater than 5.5 wt %, or not greater than 5.0 wt %, or not greater than 4.5 wt %, or not greater than 4.0 wt %, based on the total weight of the curable composition.

Any plasticizer is envisioned and refers to a compound that is incorporated into the composition and reduces the modulus of the cured membrane. A plasticizer is typically used when a solid tackifier is part of the curable composition. Suitable plasticizers include, but are not limited to, for example, a phthalate, an adipate, an aromatic oil, an aliphatic oil, a naphthalic oil, tri-ethylene glycol, di-ethylene glycol, polyethylene glycol, an organic ester, a low T_{g} oligomer, and the like. “Low T_{g} oligomer” as used herein refers to an oligomer having a glass transition temperature in a range of −90° C. to 30° C. When present, any amount of plasticizer is envisioned and includes, for example, an amount of 5 wt % to 40 wt %, or 10 wt % to 35 wt %, or 15 wt % to 30 wt %, based on the total weight of the curable composition.

A rheology modifier is an additive used to change the flow of the curable composition. In an embodiment, the rheology modifier includes, but is not limited to, a gum, a cellulosic, an alkali swellable emulsion (ASE), a hydrophobically modified alkali swellable emulsion (HASE), a hydrophobically modified polyurethane (HEUR), a hydrophobically modified polyether (HMPE), an attapulgite, a castor oil, a wax, a urea based thixotrope, an oxidized polyethylene, a polyamide, or any combination thereof. Any amount is envisioned and when present includes, for example, an amount of the rheology modifier of at least 0.3 wt %, or at least 0.5 wt %, or at least 0.8 wt %, or at least 1.0 wt %, based on the total weight of the curable composition. In an embodiment, an amount of the rheology modifier is not greater than 3.0 wt %, or not greater than 2.5 wt %, or not greater than 2.0 wt %, or not greater than 1.5 wt %, or not greater than 1.0 wt %, based on the total weight of the curable composition.

A catalyst is an additive that facilitates the cure reaction between the components. An exemplary catalyst includes, but is not limited to, a tin-based catalyst, a bismuth-based catalyst, a zinc-based catalyst, a titanium-based catalyst, or any combination thereof. Any amount is envisioned and when present includes, for example, an amount of the catalyst of at least 0.3 wt %, or at least 0.5 wt %, or at least 0.8 wt %, based on the total weight of the curable composition. In an embodiment, an amount of the catalyst is not greater than 3.0 wt %, or not greater than 2.5 wt %, or not greater than 2.0 wt %, or not greater than 1.5 wt %, or not greater than 1.0 wt %, based on the total weight of the curable composition.

A light stabilizer is an additive used to resist degradation caused by UV exposure by scavenging radicals. Any light stabilizer is envisioned and includes, for example, a hindered amine. A UV absorber is an additive that absorbs UV radiation in place of the binder or polymer system. Any UV absorber is envisioned and includes, but is not limited to, for example, benzotriazole-based UV absorbers, benzophenone-based UV-absorbers, triazine-based UV absorbers, or inorganic UV absorbers, or any combination thereof.

An adhesion promoter is an additive that enhances adhesion between two dissimilar materials, often by improving the compatibility at the interface. Any adhesion promoter is envisioned and includes, but is not limited to, for example, amino silanes, or epoxysilanes, or vinyl silanes, or methacryloxy silanes, or any combination thereof.

Antioxidants are additives in coating formulations, protecting the coatings from oxidative degradation caused by exposure to heat, light, and oxygen. Any anti-oxidant is envisioned and includes, but is not limited to, for example, phenolic, or phosphite, or thiol ether, or multifunctional antioxidants, or any combination thereof.

In the curable composition, moisture scavengers are additives typically used to prevent premature curing and extend the shelf life of the curable composition as sealant. Any moisture scavenger is envisioned and includes, for example, an organosilane such as vinyltrimethoxysilane, methyltrimethoxysilane, phenyltrimethoxy silane, an epoxy functional silane, a molecular sieve, calcium oxide, activated alumina, or any combination thereof.

In an embodiment, a defoamer may be included in the curable composition to prevent or eliminate foam during manufacturing, mixing, and/or application. Foam can lead to defects, reduced mechanical properties, and aesthetic issues in the final product. Any defoamers is envisioned and includes, for example, silicone-based defoamers, mineral-oil based defoamers, polymer based defoamers, or silica-based defoamers, or any combination thereof.

In a particular embodiment, pigments may be added to the curable composition to provide color, opacity, and/or sometimes even functional properties (such as UV resistance). Any pigment is envisioned and includes, for example, inorganic pigments, organic pigments, or carbon black, or any combination thereof.

Reactive diluents are additives that may be used in the curable composition, to reduce the viscosity of the mixture during processing while maintaining or enhancing the final properties of the cured product. Any reactive diluent is envisioned and includes, for example, silane based reactive diluents, or epoxy based reactive diluents, or acrylic based reactive diluents, or vinyl based reactive diluents, or any combination thereof.

In the present invention, a combination-product, such as a waterproofing kit, for preparing a curable composition is provided. In an example, the waterproofing kit includes a first composition and optionally, a second composition. In an embodiment, the first composition and/or the second composition includes the at least one silane-modified polymer and at least one tackifier, a polymeric additive, or combination thereof and optionally at least one latex emulsion. In a more particular embodiment, the first composition, the second composition, or a combination thereof further includes a dispersant, and any other optional additive such as, for example, a filler, a plasticizer, a rheology modifier, a catalyst, an antioxidant, a UV absorber, a light stabilizer, a defoamer, a polymeric additive, or any combination thereof.

In an embodiment, the waterproofing kit comprising the curable composition as disclosed hereinabove is a “one component” system, comprising only the first composition including the at least one silane-modified polymer and a tackifier, a polymeric additive, or combination thereof. In the “one component” curable composition, first composition reacts with moisture and initiate curing of the curable composition, the moisture maybe from a construction surface or ambient environment, or separately added.

In a particular embodiment, the waterproofing kit comprising the curable composition as disclosed hereinabove is a “two component system”, where the first composition includes the at least one silane-modified polymer and the second composition includes the at least one latex emulsion; the second component being substantially free of the at least one silane-modified polymer. In an embodiment, the two-component system may include a tackifier, a polymeric additive, or combination thereof. In another embodiment of the waterproofing kit, the two-component system may be substantially free of a tackifier. When mixed together, the first composition and the second composition react and initiate curing of the curable composition. In an embodiment, the combination product is designed for forming a curable composition by mixing the first composition and the second composition in a volume ratio of from 1:99 to 99:1, such as 1:75 to 75:1, such as 1:50 to 50:1, such as 1:25 to 25:1, such as 1:10 to 10:1, or even 1:8 to 8:1. Any order of mixing may be envisioned. Any number of compositions is envisioned. Further, any combination of components in the first composition and/or second composition and/or additional compositions is envisioned to separate the components that will cure when mixed together.

The separate parts of the exemplary waterproofing kit as described above are preferably shipped (in separate containers or packages) to the installation or job site, where they are combined (such as by spraying through a single nozzle where they are conveniently mixed together), and applied onto the base of the object penetrating through a waterproofing membrane to form a waterproofing seal, after which the coating begins to harden and form a waterproofing membrane. In an embodiment, the waterproofing curable composition substantially covers the entire surface of a functional layer or a construction surface. In another embodiment, the waterproofing curable composition layer is used in place of the waterproofing membrane.

Further disclosed is a method of waterproofing a construction surface. For instance, the method may include integrating a pre-applied waterproofing membrane installed against any vertical or horizontal construction surface. The construction surface may include, but is not limited to a soil retention structure and/or base slab. In an embodiment, the construction surface has at least one article protruding out of the construction surface and/or penetrating through the pre-applied waterproofing membrane. The method of waterproofing the construction surface includes the steps of: a) applying a liquid layer of a curable composition adjacent to a properly prepared soil retention structure and/or base slab, such as over the construction surface, wherein the curable composition is disclosed hereinabove; and b. allowing the curable composition to cure, to form a solid waterproofing layer. In an embodiment, the method further includes applying a layer of hydratable cementitious composition, such as wet concrete, against or over the waterproofing layer and hardening the hydratable cementitious composition to form a hardened concrete, wherein a peel adhesion between the hardened concrete and the waterproofing layer is at least 3.0 pounds per linear inch (pli) or 0.525 Newtons per mm according to modified ASTM D903-98(2017). In an embodiment, the construction surface is selected from among concrete, metal, polyolefin, a polyester, a polyurethane, a polystyrene, polyvinylchloride, an acrylic, a styrenic block copolymer, a silicone, ethylene propylene diene monomer, a textile, a foam, a coating, a bituminous composite, or any combination thereof, and wherein upon curing, the cured composition exhibits an adhesion of at least 3 pli or 3 to 100 pli, or 3 to 75 pli, or 3 to 60 pli, 3 to 50 pli, or 5-40 pli, according to ASTM D903-98(2017) to the construction surface on which it is applied. As used herein, “textile” includes, but is not limited to, woven fabrics, non-woven fabrics, geotextile, mesh, or any combination thereof.

In some embodiments, the soil-retention system is selected from the group consisting of lagging, formwork, shotcrete, a diaphragm wall, the like, or any combination thereof. In an embodiment, the base slab is selected from the group consisting of a mud slab, a concrete slab, a protection slab, crushed stone, the like, or any combination thereof. “A properly prepared” soil retention structure and/or base slab is a structure that is prepared for liquid application, including but not limited to a waterproofing membrane, or other of material such as sheet, fabric, foam, regulating layer, the like, or any combination thereof to smooth the surface of the retention structure and/or base slab.

The method disclosed herein may further include a construction surface that includes at least one article protruding out of the construction surface, and wherein the step of applying a liquid layer of the curable composition over the construction surface further includes applying the liquid layer of the curable composition at a base of the at least one article. In an embodiment, the at least one article is selected from the group a pipe, a steel reinforcement bar, a rock anchor, a screw, or any combination thereof. In an embodiment, the construction surface may further include a functional layer disposed over the construction surface and wherein the step of applying a liquid layer of the curable composition includes applying the liquid layer of the curable composition over a surface of the functional film. The functional layer can be a barrier layer or a non-barrier layer. In an embodiment, the functional layer is a single layer. In another embodiment, the functional layer comprises multiple layers. Any reasonable material is envisioned for the functional layer and includes, but is not limited to, a polyolefin, a polyester, a polyurethane, a polystyrene, a styrenic block copolymer, a silicone, an acrylic, an ethylene-propylene diene monomer (EPDM), a textile, a bituminous composite, a foam, or any combination thereof. In an embodiment, the barrier layer is a film including a cured composition, a polymer coating or a polymer based material, a polyolefin, a polyester, a polyurethane, a polystyrene, an acrylic, a styrenic block copolymer, a silicone, ethylene propylene diene monomer, a textile, a foam, a bituminous composite, or any combination thereof. In an embodiment, the functional layer is a foam including a polyolefin, a polyester, a polyurethane, a polystyrene, an acrylic, a styrenic block copolymer, a silicone, a bituminous composite, or any combination thereof.

According to the “reverse tanking” waterproofing technique, a waterproofing membrane is first attached with the back side of its carrier sheet against a “formwork” (i.e., concrete mold usually formed by wooden boards joined together). Consequently, the waterproofing adhesive layer faces outwards. A concrete structure is created by casting concrete against the membrane-covered formwork surface, and this may be referred to as “post cast” or “post applied” concrete. In an embodiment, the adhesive layer is covered by an elastomeric protective coating layer, a particle coating layer, or mixture or arrangement of both (i.e., either individually, mixed together as one layer, or arranged as discrete layers), to protect the adhesive from dirt and damage. This protective coating layer (whether polymeric or particle coating) also operates to decrease the tack of the adhesive. The outer surface is further protected by a release sheet liner (that must be removed before fresh concrete is poured against the adhesive/protective coating layers). After curing, the concrete is bonded with the adhesive/protective coating layers, and thus a waterproofing bond is achieved in “reverse” order.

Hence, in the world of “reverse tanking” waterproofing, it can be said that the waterproofing is “pre-applied” because it precedes the concrete structure; and, in turn, the concrete is said to be “post cast” or “post-applied” because it follows the installation of waterproofing.

Reverse tanking is further discussed in U.S. Pat. Nos. 5,496,615 and 6,500,520 which teach using particle coating layers. In the '615 patent, inorganic particles are used to resist foot traffic when the membrane is installed on a horizontal surface. In the '520 patent, particles are applied on top of an adhesive layer to enhance bonding with concrete by reacting with calcium hydroxide generated during the hydration of cement.

One of the difficulties of reverse tanking is achieving continuity of waterproofing in detail areas (i.e., surface irregularities), and especially in “tieback” detailing. Tiebacks are the terminal ends of rods or cables supporting the formwork and are found protruding at intervals through the formwork surface. Other surface irregularities include penetration areas, such as where pipes or pile caps extend through the formwork. Common surface irregularities are found in soil-retention systems such as any one of lagging, formwork, shotcrete, mud slabs, or crushed stone against which is disposed or attached a plurality of waterproofing membranes having a synthetic polymer sheet, nonwoven, or mesh sheet-like body or synthetic polymer pressure-sensitive adhesive; and the plurality of sheet-like waterproofing membranes having at least two penetrations from articles chosen from pipe, steel reinforcement bar, rock anchor, a screw, a pile cap, a concrete column, the like, or any combination thereof.

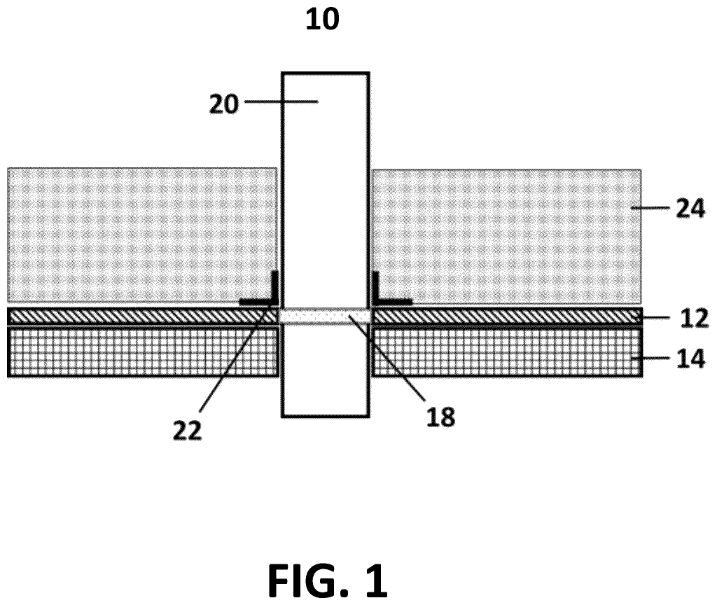

FIG. 1 illustrates an exemplary system 10 including penetrating objects, such as an article 20 protruding out of the construction surfaces 12, 14, and 24, that can be waterproofed by the curable composition disclosed herein. In system 10, at least one and, more preferably, a plurality of waterproofing membranes 12 are attached or fastened to a lagging formwork 14. For ease of illustration, one example waterproofing membrane 12 is shown, having at least one perforation 18 through which an article, such as a metal structure 20 extends (i.e., at least one penetration) and protrudes out of the construction surfaces 12, 14, and 24. The metal structure 20 can be a pipe, steel reinforcing bar (“rebar”), fastener, a rock anchor, screws, tie-back, or other object. Exemplary waterproofing curable composition 22 of the present invention is applied at the penetration area, at the base of the article 20, to bond with the membrane 12, with the metal structure 20, and with post-cast concrete 24, whereby the waterproofing curable composition 22 can also acts as a sealant. In an embodiment, the waterproofing curable composition 22 substantially covers the entire surface of the waterproofing membrane 12. In another embodiment, the waterproofing curable composition layer 22 is used in place of the waterproofing membrane 12.

The composition of the waterproofing membrane 12 is not critical to the present invention and the membrane can be any waterproofing single or multi-layer membrane known to those skilled in the art such as, for example, those disclosed in U.S. Pat. Nos. 8,475,909 and 10,267,049 as well as products sold under the PREPRUFE® brand name by GCP Applied Technologies, Inc.

Referring to FIG. 1, once cured, the curable composition forms a waterproofing layer 22 around the article 20 penetrating in and protruding out through the pre-applied waterproofing membrane to seal and waterproof the base of the penetrating article 20 where it intersects with the pre-applied waterproofing membrane. In some embodiments, the curable composition is applied at a thickness of from 0.05 mm to 50 mm. In other embodiments, the curable composition is applied at a thickness of from 1 to 25 mm.

Components of the curable composition can be applied by any means known in the art. In an embodiment, the components of the curable composition are applied by spray-coating. As used herein, the term “spray-coating” means establishing a coating layer onto a substrate, such as a pre-applied waterproofing membrane and an object penetrating through, a composition that hardens into a membrane. The spray-coating is typically done by spraying two parts of the composition which are blended within the spray-nozzle or piping or tubing or other conduit that feeds coating composition components from storage containers or tanks to the spray nozzle. The use of two-component systems in spray applications is known in the art.

By “hardened”, those having skill in the waterproofing of buildings and construction will understand that the waterproofing membrane/seal should be dry to hand touch and should not displace (in the manner of a liquid) when spray-applied onto the substrate.

The curable compositions provide for excellent bonding among components used for establishing a monolithic barrier in a pre-applied waterproofing construction application, even if varied materials, surfaces, and surface texturing are involved, and especially where seams and penetrations occur and various surfaces of waterproofing membranes, pipes and other conduits, rebar, and other materials come into contact.

Embodiments of the current invention provide a beneficial combination of properties, for example, the curable composition exhibits adhesion to both a plastic substrate and post-cast concrete, such that it could be applied directly onto a waterproof sheet and produce a layer that is operative to bond to both the waterproofing membrane and provide the unique bond to post-cast concrete.

The waterproofing membrane of the cured composition has desirable properties. For instance the waterproofing membrane has a desirable hardness. For instance, the shore A hardness is in a range of 30 to 95, as measured by ASTM D2240-15(2021). The shore A hardness is an indicator of a flexible material.

The method of the present invention includes the step of applying concrete against the pre-applied waterproofing membrane and around the at least one penetration sealed by the curable composition and allowing the concrete to harden against and adhere to the membranes and curable composition, wherein the peel adhesion between the hardened concrete and cured composition is at least 3.0 pounds per linear inch (pli) or 0.525 Newtons per mm according to modified ASTM D903-98(2017), as described in the Examples. This adhesion functions to resist water migration in the event that water reaches the concrete-membrane interface.

In one embodiment, upon curing, the cured composition exhibits an adhesion greater than 3 pounds per linear inch (pli) according to modified ASTM D903-98(2017) to the concrete cast against it. In another embodiment, upon curing, the cured composition exhibits an adhesion greater than 3 pli according to ASTM D903-98(2017) to the substrate on which it is applied, selected from among concrete, metal, HDPE, PVC, and other plastic sheets or films. In an embodiment, the cured composition has an adhesion of at least 3.0 pounds per linear inch (pli) to a substrate including post-cast concrete, primed concrete, unprimed concrete, wood, polymer, metal, cement board, textile, foam, coating, or any combination thereof.

The method of the present invention can be used to waterproof below-grade structures.

The cured membrane composition disclosed herein can be used in a variety of ways when acting as a barrier to water, air, and/or vapor. When functioning as a waterproofing membrane, it can be applied as a detailing membrane-such as at overlaps, seams, pipe or rebar penetrations, or other high-risk areas for water penetration-due in part to its liquid application. As a detailing membrane, the composition can function in conjunction with other waterproofing membranes, such as GCP's PREPRUFE® membranes.

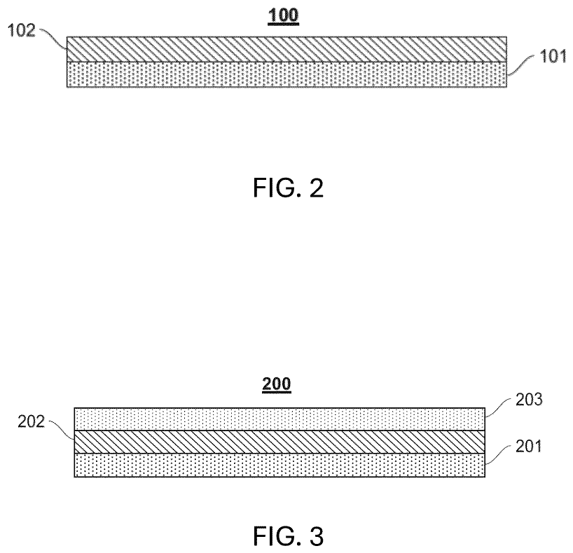

In a particular embodiment and as shown in FIG. 2, the cured curing composition may be used as part of a waterproofing article 100 where the cured curing composition is a waterproofing layer 102 that is disposed over a first functional layer, such as a barrier layer 101, the barrier layer 101 configured to provide moisture barrier, a vapor barrier, or any combination thereof. In another embodiment, the cured curing composition may be used as part of a waterproofing article 100 where the cured curing composition is a waterproofing layer 102 that is disposed over a construction surface 101. The waterproofing article may include any other layers envisioned. In an embodiment and as shown in FIG. 3, a waterproofing article 200 includes a particulate layer 203 disposed on at least a portion of the waterproofing layer 202 on a side opposite a barrier layer 201.

In an embodiment, the particulate layer 203 includes a particulate material embedded in a surface of the waterproofing layer 202. In embodiments, the particulate materials may be at least partially embedded in and partially protruding from a top surface of the waterproofing layer 202. The particulate material can include granules, sand, a swellable clay, cement, hydrated cement, limestone, slag fly ash, or any combination thereof. The particulate materials may further include a functional coating. The particulate material can have a median particle size of at least 10 microns and no greater than 5000 microns or at least 100 microns and no greater than 1000 microns. Particle sizes of particulate materials may be measured with light scattering using 405 and 650 nm light source with a Horiba LA-950v2 detector.

In an embodiment, the particulate material 203 may have a particular coating density that may provide improved performance and/or manufacturing of the waterproofing article. In an embodiment, the coating density of the particulate material can be at least 0.01 lbs/sq ft. or at least 0.02 lbs/sq ft. or at least 0.03 lbs/sq ft. or at least 0.04 lbs/sq ft. or at least 0.05 lbs/sq ft. In an embodiment the coating density of the particulate material can be no greater than 0.6 lbs/sq ft. or no greater than 0.5 lbs/sq ft. or no greater than 0.4 lbs/sq ft. In an embodiment the coating density of the particulate material can be in the range of 0.01 lbs/sq ft. to 0.6 lbs/sq ft., or 0.03 lbs/sq ft. or to 0.5 lbs/sq ft., or 0.05 lbs/sq ft. to 0.4 lbs/sq ft.

In an embodiment, a top surface 203 of the front side of the waterproofing article 200 may have a particular reflectivity that may facilitate improved performance and/or manufacturing of the waterproofing article. In an embodiment, the top surface of the waterproofing layer 202 may have a reflectivity of at least 5% or at least 10% or at least 15% or at least 20% or at least 25% or at least 30% or at least 35% or at least 40% or at least 45% or at least 50% or at least 55% or at least 60% or at least 65% or at least 70% or at least 75% or at least 80% or at least 85% or at least 90% or at least 95%. In an embodiment, the top surface may have a reflectivity of not greater than 95% or not greater than 90% or not greater than 85% or not greater than 80% or not greater than 75% or not greater than 70% or not greater than 65% or not greater than 60% or not greater than 55% or not greater than 50% or not greater than 45% or not greater than 40% or not greater than 35% or not greater than 30% or not greater than 25% or not greater than 20% or not greater than 15% or not greater than 10% or not greater than 5%. It will be appreciated that the reflectivity may be between any of the minimum and maximum values noted above, including for example, but not limited to, at least 5% and not greater than 95% or at least 15% and not greater than 50%. Reflectivity can be measured with a NOVO-SHADE 45/0 Reflectometer. The test surface is illuminated from a 45° angle and the intensity of scattered light at the perpendicular (i.e., 0°) is measured. Data is recorded on a grey scale where black is 0% and white is 100%. Only shading is measured, irrespective of color, and is referred to as % whiteness.

In an embodiment, the waterproofing article has a peel adhesion between a hardened concrete and the waterproofing layer in a range from 3.0 to 50.0 pounds per linear inch (pli) or 0.525 to 8.756 Newtons per mm according to modified ASTM D903-98(2017), wherein a wet concrete is first applied over the waterproofing layer, which is subsequently hardened to form the hardened concrete. In an embodiment, the wet concrete is applied over the particulate layer 203. In another embodiment, the wet concrete is applied over the waterproofing layer 202, where the waterproofing article has no particulate layer.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.
Embodiment 1. A curable composition including at least one silane-modified polymer in an amount of 10-95 wt % based on the total weight of the curable composition; and at least one latex emulsion with total organic solid in an amount of 5-90 wt % based on the total weight of the curable composition.
Embodiment 2. A curable composition, including: at least one silane-modified polymer in an amount of 5-99 wt % based on the total weight of the curable composition; and at least one tackifier in an amount of at least 1 wt % based on the total weight of the curable composition.
Embodiment 3. The curable composition of any of the preceding embodiments, wherein the cured composition has an adhesion of at least 3.0 pounds per linear inch (pli) to a substrate including post-cast concrete, primed concrete, unprimed concrete, wood, polymer, metal, cement board, textile, foam, coating, or any combination thereof.
Embodiment 4. The curable composition of embodiment 1, further including at least one tackifier.
Embodiment 5. The curable composition of any of the preceding embodiments, wherein the at least one silane-modified polymer includes a silane-terminated polyether, an acrylic modified silane-terminated polyether, a silane-terminated polyacrylate, a silane-terminated polyolefin, a silane-terminated polyurethane, a silane-terminated polyester, a silane-terminated epoxy, or any combination thereof.
Embodiment 6. The curable composition of any one of the preceding embodiments, wherein the at least one silane-modified polymer includes at least two silane-terminated polyether polymers.
Embodiment 7. The curable composition of embodiment 1, wherein the amount of the at least one silane-modified polymer is at least 15 wt %, or at least 20 wt %, or at least 25 wt %, or at least 30 wt %, or at least 35 wt %, or at least 40 wt %, or at least 45 wt %, based on the total weight of the curable composition.
Embodiment 8. The curable composition of embodiment 2, wherein the amount of the at least one silane-modified polymer is at least 10 wt %, or at least 15 wt %, or at least 20 wt %, or at least 25 wt %, or at least 30 wt %, or at least 35 wt %, or at least 40 wt %, or at least 45 wt %, based on the total weight of the curable composition.
Embodiment 9. The curable composition of any one of the preceding embodiments, wherein the amount of the at least one first silane-modified polymer is not greater than 90 wt %, or not greater than 85 wt %, or not greater than 80 wt %, or not greater than 75 wt %, or not greater than 70 wt %, or not greater than 65 wt %, or not greater than 60 wt %, or not greater than 55 wt %, or not greater than 50 wt %, or not greater than 45 wt %, or not greater than 40 wt %, or even not greater than 35 wt %, based on the total weight of the curable composition.
Embodiment 10. The curable composition of any of the preceding embodiments, wherein the at least one latex emulsion includes at least one homopolymer, copolymer, or any combination thereof including an acrylate, a styrene acrylate, a silane, a siloxane, a polyvinyl, a carboxylated styrene butadiene, a styrene butadiene, a styrene isoprene, or any combination thereof.
Embodiment 11. The curable composition of any of the preceding embodiments, wherein an amount of the latex emulsion is at least 10 wt %, or at least 15 wt %, or at least 20 wt %, or at least 25 wt %, or at least 30 wt %, or at least 35 wt %, or at least 40 wt %, or at least 45 wt %, or at least 50 wt %, or at least 55 wt %, or at least 60 wt %, or at least 65 wt %, or at least 70 wt %, based on the total weight of the curable composition.
Embodiment 12. The curable composition of any one of the preceding embodiments, wherein the amount of the latex emulsion is not greater than 85 wt %, or not greater than 80 wt %, or not greater than 75 wt %, or not greater than 70 wt %, or not greater than 65 wt %, or not greater than 60 wt %, or not greater than 55 wt %, based on the total weight of the curable composition.
Embodiment 13. The curable composition of any one of the preceding embodiments, wherein the amount of the tackifier is at least 5 wt %, or at least 10 wt %, at least 15 wt %, or at least 20 wt %, or at least 25 wt %, or at least 30 wt %, based on the total weight of the curable composition.
Embodiment 14. The curable composition of any one of the preceding embodiments, wherein the amount of the tackifier is not greater than 95 wt %, or not greater than 90 wt %, or not greater than 85 wt %, or not greater than 80 wt %, or not greater than 75 wt %, or not greater than 70 wt %, or not greater than 65 wt %, or not greater than 60 wt %, or not greater than 55 wt %, or not greater than 50 wt %, or not greater than 40 wt %, or not greater than 35 wt %, or not greater than 30 wt %, or not greater than 25 wt %, based on the total weight of the curable composition.
Embodiment 15. The curable composition of any one of the preceding embodiments, wherein the tackifier includes a hydrogenated gum rosin, a glycerol ester of gum rosin, a pentaerythritol ester of gum rosin, a methyl ester of gum rosin, an aromatic hydrocarbon resin, an aliphatic hydrocarbon resin, a mixed aliphatic/aromatic resin, a terpene resin, a hydrogenated hydrocarbon resin, an alkylphenol resin, a modified phenol-formaldehyde resin, or any combination thereof.
Embodiment 16. The curable composition of embodiment 15, wherein the tackifier includes the hydrogenated gum rosin.
Embodiment 17. The curable composition of any one of the preceding embodiments, further including at least one filler.
Embodiment 18. The curable composition of embodiment 17, wherein the filler includes calcium carbonate, talc, amorphous silica, magnesium silicate, mica, graphite, white cement, fly ash, titanium oxide, silica fume, bentonite, or any combination thereof.
Embodiment 19. The curable composition of any one of embodiments 17-18, wherein the at least one filler is present at an amount of at least 20 wt %, or at least 25 wt %, or at least 30 wt %, or at least 35 wt %, based on the total weight of the curable composition.
Embodiment 20. The curable composition of any one of embodiments 17-19, wherein the at least one filler is present at an amount of not greater than 50 wt %, or not greater than 45 wt %, or not greater than 40 wt %, or not greater than 35 wt %, or not greater than 30 wt %, based on the total weight of the curable composition.
Embodiment 21. The curable composition of any one of the preceding embodiments, further including at least one dispersant.
Embodiment 22. The curable composition of embodiment 21, wherein the at least one dispersant includes a low molecular weight polymer, a high molecular weight polymer, an oligomer with an anionic functional group, an oligomer with a cationic functional group, an oligomer with a nonionic functional group, or any combination thereof.
Embodiment 23. The curable composition of any one of embodiments 21-22, wherein the at least one dispersant is present at an amount of at least 0.1 wt %, or at least 0.5 wt %, or at least 1.0 wt %, or at least 1.5 wt %, or at least 2.0 wt %, based on the total weight of the curable composition.
Embodiment 24. The curable composition of any one of embodiments 21-23, wherein the at least one dispersant is present at an amount of not greater than 6.0 wt %, or not greater than 5.5 wt %, or not greater than 5.0 wt %, or not greater than 4.5 wt %, or not greater than 4.0 wt %, based on the total weight of the curable composition.
Embodiment 25. The curable composition of any one of the preceding embodiments, further including at least one plasticizer.
Embodiment 26. The curable composition of embodiment 25, wherein the plasticizer includes a phthalate, an adipate, an aromatic oil, an aliphatic oil, a naphthalic oil, tri-ethylene glycol, di-ethylene glycol, polyethylene glycol, an organic ester, a low T_{g} oligomer, or any combination thereof.
Embodiment 27. The curable composition of any one of embodiments 25-26, wherein an amount of the plasticizer is 5 wt % to 40 wt %, or 10 wt % to 35 wt %, or 15 wt % to 30 wt %, based on the total weight of the curable composition.
Embodiment 28. The curable composition of any one of the preceding embodiments, further including a rheology modifier.
Embodiment 29. The curable composition of embodiment 28, wherein the rheology modifier includes a gum, a cellulosic, an alkali swellable emulsion (ASE), a hydrophobically modified alkali swellable emulsion (HASE), a hydrophobically modified polyurethane (HEUR), a hydrophobically modified polyether (HMPE), an attapulgite, a castor oil, a wax, a urea based thixotrope, an oxidized polyethylene, a polyamide, or any combination thereof.
Embodiment 30. The curable composition of any one of embodiments 28-29, wherein an amount of the rheology modifier is at least 0.3 wt %, or at least 0.5 wt %, or at least 0.8 wt %, or at least 1.0 wt %, based on the total weight of the curable composition.
Embodiment 31. The curable composition of any one of embodiments 28-30, wherein an amount of the rheology modifier is not greater than 3.0 wt %, or not greater than 2.5 wt %, or not greater than 2.0 wt %, or not greater than 1.5 wt %, or not greater than 1.0 wt %, based on the total weight of the curable composition.
Embodiment 32. The curable composition of any one of the preceding embodiments, wherein the curable composition further includes a catalyst.
Embodiment 33. The curable composition, wherein the catalyst includes a tin-based catalyst, a bismuth-based catalyst, a zinc-based catalyst, a titanium-based catalyst, or any combination thereof.
Embodiment 34. The curable composition of any one of embodiments 32-33, wherein an amount of the catalyst is at least 0.3 wt %, or at least 0.5 wt %, or at least 0.8 wt %, based on the total weight of the curable composition.
Embodiment 35. The curable composition of any one of embodiments 32-34, wherein an amount of the catalyst is not greater than 3.0 wt %, or not greater than 2.5 wt %, or not greater than 2.0 wt %, or not greater than 1.5 wt %, or not greater than 1.0 wt %, based on the total weight of the curable composition.
Embodiment 36. The curable composition of any one of the preceding embodiments, wherein the curable composition further includes a light stabilizer, an antioxidant, a UV absorber, a moisture scavenger, an adhesion promoter, a defoamer, or any combination thereof.
Embodiment 37. A method of waterproofing a construction surface, the method including: a. applying a liquid layer of the curable composition according to any one of embodiments 1-36 over the construction surface; and b. allowing the curable composition to cure, to form a solid waterproofing layer.
Embodiment 38. The method of embodiment 37 further comprising applying a layer of hydratable cementitious composition over the waterproofing layer and hardening the hydratable cementitious composition to form a hardened concrete, wherein a peel adhesion between the hardened concrete and the waterproofing layer is at least 3.0 pounds per linear inch (pli) or 0.525 Newtons per mm according to modified ASTM D903-98(2017).
Embodiment 39. The method of any one of embodiments 37-38, wherein the construction surface includes a soil-retention structure or a base slab.
Embodiment 40. The method of embodiment 39, wherein the soil-retention structure is selected from the group consisting of lagging, formwork, shotcrete, a diaphragm wall, or any combination thereof.
Embodiment 41. The method of embodiment 39, wherein the base slab is selected from the group consisting of a mud slab, a concrete slab, a protection slab, crushed stone, or any combination thereof.
Embodiment 42. The method of any one of embodiments 37-41, wherein the construction surface further includes at least one article protruding out of the construction surface, and wherein the step of applying a liquid layer of the curable composition over the construction surface further includes applying the liquid layer of the curable composition at a base of the at least one article.
Embodiment 43. The method of embodiment 42, wherein the at least one article is selected from the group a pipe, a steel reinforcement bar, a rock anchor, a screw, a pile cap, a concrete column, or any combination thereof.
Embodiment 44. The method of any one of the embodiments of 37-43, wherein the construction surface further includes a functional layer disposed over the construction surface and wherein the step of applying a liquid layer of the curable composition includes applying the liquid layer of the curable composition over a surface of the functional layer.
Embodiment 45. The method of embodiment 44, wherein the functional layer is a film including a polyolefin, a polyester, a polyurethane, a polystyrene, an acrylic, a styrenic block copolymer, a silicone, ethylene propylene diene monomer, a textile, a foam, a bituminous composite, or any combination thereof.
Embodiment 46. The method of any one of embodiments 44-45, wherein the functional layer is a foam including a polyolefin, a polyester, a polyurethane, a polystyrene, an acrylic, a styrenic block copolymer, a silicone, a bituminous composite, or any combination thereof.
Embodiment 47. The method of any one of embodiments 37-46, wherein an average thickness of the liquid layer is at least 0.05 mm and not greater than 50 mm, such as at least 1 mm and not greater than 25 mm.
Embodiment 48. The method of any one of embodiments 37-47, wherein the construction surface is selected from among concrete, metal, polyolefin, a polyester, a polyurethane, a polystyrene, polyvinylchloride, an acrylic, a styrenic block copolymer, a silicone, ethylene propylene diene monomer, a textile, a foam, a bituminous composition, or any combination thereof, and wherein upon curing, the cured composition exhibits an adhesion of at least 3 pli or 3 to 100 pli, or 3 to 75 pli, or 3 to 60 pli, 3 to 50 pli, or 5-40 pli, according to ASTM D903-98(2017) to the construction surface on which it is applied.
Embodiment 49. A below-grade waterproofing system made according to the method of any one of embodiments 37-48.
Embodiment 50. A waterproofing kit including a first composition including at least one silane-modified polymer; and an optionally a second composition including at least one latex emulsion with total organic solid in an amount of 5-90 wt %, wherein the first composition and/or the second composition include at least one tackifier, a polymeric additive, or a combination thereof in an amount of at least 1 wt %, and wherein the amounts in wt % are based on the total weight of the curable composition.
Embodiment 51. The waterproofing kit of embodiment 50, wherein the at least one latex emulsion includes at least one homopolymer, copolymer, or any combination thereof including an acrylate, a styrene acrylate, a silane, a siloxane, a polyvinyl, a carboxylated styrene butadiene, a styrene butadiene, a styrene isoprene, or any combination thereof.
Embodiment 52. The waterproofing kit of any one of embodiments 50-51, wherein the first composition includes the silane-terminated polymer and the second composition includes the at least one latex.
Embodiment 53. The waterproofing kit of any one of embodiments 50-52, wherein the tackifier includes a hydrogenated gum rosin, a glycerol ester of gum rosin, a pentaerythritol ester of gum rosin, a methyl ester of gum rosin, an aromatic hydrocarbon resin, an aliphatic hydrocarbon resin, a mixed aliphatic/aromatic resin, a terpene resin, a hydrogenated hydrocarbon resin, an alkylphenol resin, a modified phenol-formaldehyde resin, or any combination thereof.
Embodiment 54. The waterproofing kit of any one of embodiments 50-53, wherein the first composition, the second composition, or any combination thereof includes a dispersant.
Embodiment 55. The waterproofing kit of any one of embodiments 50-54, wherein the kit further includes instructions for forming a curable composition by mixing the first composition and the second composition in a volume ratio of from 1:99 to 99:1, and forming a waterproofing layer after curing the curable composition, wherein the waterproofing layer has a Young's modulus (E) of at least 0.05 MPa and not greater than 10 MPa.
Embodiment 56. The waterproofing kit of any one of embodiments 50-55, wherein the first composition and/or the second composition further includes at least one additive selected from a filler, a plasticizer, a rheology modifier, a catalyst, an antioxidant, a UV absorber, a light stabilizer, a defoamer, a moisture scavenger, an adhesion promoter, a wax, a reactive diluent, a polymeric additive, or any combination thereof.
Embodiment 57. A waterproofing article including a waterproofing layer disposed over at least a portion of a barrier layer, wherein the waterproofing layer is formed of the cured curable composition according to embodiment 1, and wherein the barrier layer is configured to provide moisture and/or vapor barrier.
Embodiment 58. The waterproofing article of embodiment 57, further comprising a particulate layer disposed over at least a portion of the waterproofing layer on a side opposite the barrier layer.
Embodiment 59. The waterproofing article of any one of embodiments 57-58, wherein the barrier layer comprises a film or a foam.
Embodiment 60. A curable composition includes at least one silane-modified polymer in an amount of 10-95 wt % based on the total weight of the curable composition; and at least of one a polymeric additive in an amount of at least 1 wt %, a tackifier in an amount of at least 1 wt %, a latex emulsion with total organic solid in an amount of 5-90 wt %, or a combination thereof, based on the total weight of the curable composition.

While the invention is described herein using a limited number of embodiments, these specific embodiments are not intended to limit the scope of the invention as otherwise described and claimed herein. Modifications and variations from the described embodiments exist. More specifically, the following examples are given as a specific illustration of embodiments of the claimed invention. It should be understood that the invention is not limited to the specific details set forth in the examples. All parts and percentages in the examples, as well as in the remainder of the specification, are by weight of the total liquid curable composition, unless otherwise specified.

### EXAMPLES

Comparative Example—A liquid waterproofing composition was prepared for comparison by making a solution of typical silane-terminated polymer (STPE) sealant formulation. Prescribed amounts of STPEs, plasticizer, filler, rheology modifier, moisture scavengers, adhesion promoters and catalyst were added and mixed by speed mixer. An approximately 1 to 2 mm thick membrane was cast on a reinforcing layer at ambient temperature and humidity. After the membrane was cured for 2 days, concrete was cast against the air-facing surface of the membrane. About seven (7) days after concrete casting, membranes were peeled off during the un-molding, indicating no adhesion to concrete. As such, the comparative example showed that without a tackifier, a polymeric additive, a latex, or any combination thereof, there was no adhesion to concrete. Formulations and results can be seen in Table 1.

TABLE 1
Comparative Example

| | |
|---|---|
| Poly-ether based α-silane modified | 10.1 |
| polymer (wt %) | |
| Poly-ether based di-methoxysilyl | 10.1 |
| terminated polymer (wt %) | |
| Non-phthalate Plasticizer (wt %) | 15.2 |
| Calcium Carbonate Filler (wt %) | 38.7 |
| High purity Silica Filler (wt %) | 20.2 |
| Amide-wax Rheology Modifier (wt %) | 1.5 |
| Pigment (wt %) | 0.3 |
| Moisture Scavenger (wt %)- vinyl | 0.4 |
| triethoxy silane | |
| Adhesion Promoter - oligomeric | 0.7 |
| diamino silane (wt %) | |
| Adhesion Promoter - (glycidoxy | 0.4 |
| functionalized silane) (wt %) | |
| Adhesion Promoter- (octyl | 1.4 |
| functionalized silane) (wt %) | |
| Tin catalyst (wt %) | 1 |
| Peel adhesion to concrete (pli) | 0 |

Example 1—An exemplary liquid waterproofing composition was prepared by first making a solution of prescribed amounts of solid tackifier dissolved in a plasticizer in a stirring plate overnight. The following day, a silane-terminated polymer (STPE), filler, rheology modifier and catalyst were added and mixed by speed mixer. An approximately 1 to 2-mm thick membrane was cast on a reinforcing layer at ambient temperature and humidity. After the membrane was fully cured for 3 to 7 days, concrete was cast against the air-facing surface of the membrane. About seven (7) days after concrete casting, 90° peel adhesion between the membrane and the concrete cast thereon was tested according to modified ASTM D903-98 (2017). As used herein, the modified ASTM D903-98(2017) refers to the modification of peeling angle to 90° from 180° and a separation rate/pulling rate to 2 inches per minute from 12 inches per minute. Adhesion to concrete was found to be between 6.2 and 8.5 pli depending on combination of different amounts of STPE, tackifier and filler. Formulations and results can be seen in Table 2.

TABLE 2

| | Exp 1.1 | Exp 1.2 | Exp 1.3 |
|---|---|---|---|
| Polyether based α-silane | 9.8 | 9.8 | 9.8 |
| modified polymer (wt %) | | | |
| Polyether based di-methoxysilyl | 9.8 | 9.8 | 9.8 |
| terminated polymer (wt %) | | | |
| Non-phthalate Plasticizer (wt %) | 19.6 | 19.6 | 19.6 |
| Calcium Carbonate Filler (wt %) | 44.1 | 29.4 | 39.2 |
| Rosin ester tackifier (wt %) | 14.7 | 29.4 | 19.6 |
| Amide-wax Rheology | 1 | 1 | 1 |
| Modifier (wt %) | | | |
| Tin catalyst (wt %) | 1 | 1 | 1 |
| Peel adhesion to concrete (pli) | 6.2 | 8.5 | 7.5 |

Example 2—An exemplary liquid waterproofing composition was prepared by making a solution of prescribed amounts of STPEs, liquid tackifier, filler, rheology modifier and catalyst by speed mixer. An approximately 1 to 2-mm thick membrane was cast on a reinforcing layer at ambient temperature and humidity. After the membrane was fully cured for 3 to 9 days, concrete was cast against the air-facing surface of the membrane. About seven (7) days after concrete casting, 90° peel adhesion between the membrane and the concrete cast thereon was tested according to modified ASTM D903. Adhesion to concrete was found to be between 5.5 and 10.4 pli depending on combination of different amounts of STPE, tackifier and filler. Formulations and results can be seen in Table 3.

TABLE 3

| | Exp 2.1 | Exp 2.2 | Exp 2.3 | Exp 2.4 |
|---|---|---|---|---|
| Polyether based α-silane | 14.1 | 14 | 14 | 0 |
| modified polymer (wt %) | | | | |
| Polyether based di-methoxysilyl | 14.1 | 14 | 14 | 20 |
| terminated polymer (wt %) | | | | |
| Calcium carbonate Filler (wt %) | 35.4 | 35 | 35 | 35 |
| Ester of hydrogenated resin | 35.4 | 35 | 35 | 43 |
| tackifier (wt %) | | | | |
| Tin Catalyst (wt %) | 1.0 | 1 | 1 | 1 |
| Amide-wax Rheology | 0 | 1 | 1 | 1 |
| Modifier (wt %) | | | | |
| Peel adhesion to concrete (pli) | 8.4 | 5.5 | 6.2 | 10.4 |

Example 3—An exemplary liquid waterproofing composition was prepared by first making a solution of prescribed amounts of two different components; (1) silane terminated polymers (STPE) that makes the body of sealant and helps to adhesion, (2) aqueous latex/emulsion added as reactive diluent and to help adhesion, and calcium carbonate followed by dispersing prescribed amounts dispersant agent into the solution to achieve a homogeneous mixture, if necessary. Component (2) was premixed by using a speed mixer and then combined with (1) by mixing in speed mixer. Prescribed amounts of dispersant agent were added to the mixture to help with dispersion if necessary. An approximately 1 to 2-mm thick membrane was cast on a reinforcing layer at ambient temperature and humidity. Skin formation started in about one (1) hour, and full curing achieved overnight. After the membrane was fully cured, concrete was cast against the air-facing surface of the membrane. About seven (7) days after concrete casting, 90° peel adhesion between the membrane and the concrete cast thereon was tested according to modified ASTM D903. Adhesion to concrete was found to be between 8 and 10.5 pli depending on combination of different combination of STPE, latex and filler. Formulations and results can be seen in Table 4.

TABLE 4

| | Exp 3.1 | Exp 3.2 | Exp 3.3 |
|---|---|---|---|
| Poly-ether based α-silane | 0 | 0 | 24.3 |
| modified polymer (wt %) | | | |
| Poly-ether based di-methoxysilyl | 16.7 | 16.7 | 0 |
| terminated polymer (wt %) | | | |
| Aqueous latex/emulsion (wt %) | 66.6 | 66.6 | 48.5 |
| Calcium Carbonate Filler (wt %) | 16.7 | 16.7 | 24.3 |
| Unsaturated polycarboxylic acid | 0 | 0 | 2.9 |
| polymer with a polysiloxane | | | |
| copolymer Dispersing agent (wt %) | | | |
| Peel adhesion to concrete (pli) | 9.6 | 8 | 10.5 |

As seen, exemplary STPE systems demonstrated remarkable adhesion to post-cast concrete.

The foregoing examples and embodiments were present for illustrative purposes only and not intended to limit the scope of the invention.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall there between.

What is claimed is:

1. A curable composition, comprising:
at least one silane-modified polymer; and
at least one of:
(i) a latex emulsion with total organic solid in an amount of 5-90 wt %,
(ii) a tackifier in an amount of at least 1 wt %,
(iii) a polymeric additive, or
(iv) a combination thereof,
wherein the amounts in wt % are based on the total weight of the curable composition.

2. The curable composition of claim 1, wherein upon curing the curable composition to form a cured composition, the cured composition has an adhesion of at least 3.0 pounds per linear inch (pli) to a substrate comprising post-cast concrete, primed concrete, unprimed concrete, wood, polymer, metal, cement board, textile, foam, coating, or any combination thereof.

3. The curable composition of claim 1, wherein the at least one silane-modified polymer comprises a silane-terminated polyether, an acrylic-modified silane-terminated polyether, a silane-terminated polyacrylate, a silane-terminated polyolefin, a silane-terminated polyurethane, a silane-terminated polyester, a silane-terminated epoxy, or any combination thereof.

4. The curable composition of claim 1, wherein the at least one silane-modified polymer comprises at least two silane-terminated polyether polymers.

5. The curable composition of claim 1, wherein the amount of the at least one silane-modified polymer is at least 5 wt. %, or at least 10 wt. %, or at least 15 wt %, or at least 20 wt %, or at least 25 wt %, or at least 30 wt %, or at least 35 wt %, or at least 40 wt %, or at least 45 wt %, based on the total weight of the curable composition and not greater than 99 wt %, or not greater than 95 wt %, or not greater than 90 wt %, or not greater than 85 wt %, or not greater than 80 wt %, or not greater than 75 wt %, or not greater than 70 wt %, or not greater than 65 wt %, or not greater than 60 wt %, or not greater than 55 wt %, or not greater than 50 wt %, or not greater than 45 wt %, or not greater than 40 wt %, or even not greater than 35 wt %, based on the total weight of the curable composition.

6. The curable composition of claim 1, wherein the at least one latex emulsion comprises at least one homopolymer, copolymer, or any combination thereof, and comprising an acrylate, a styrene acrylate, a silane, a siloxane, a polyvinyl, a carboxylated styrene butadiene, a styrene butadiene, a styrene isoprene, or any combination thereof.

7. The curable composition of claim 1, wherein the amount of the tackifier is at least 2 wt %, or at least 3 wt %, or at least 5 wt %, or at least 10 wt %, or at least 15 wt %, or at least 20 wt %, or at least 25 wt %, or at least 30 wt % and not greater than 98 wt %, or not greater than 97 wt %, or not greater than 95 wt %, or not greater than 90 wt %, or not greater than 85 wt %, or not greater than 80 wt %, or not greater than 75 wt %, or not greater than 70 wt %, or not greater than 65 wt %, or not greater than 60 wt %, or not greater than 55 wt %, or not greater than 50 wt %, or not greater than 40 wt %, or not greater than 35 wt %, or not greater than 30 wt %, or not greater than 25 wt %, based on the total weight of the curable composition.

8. The curable composition of claim 1, wherein the tackifier comprises a hydrogenated gum rosin, a glycerol ester of gum rosin, a pentaerythritol ester of gum rosin, a methyl ester of gum rosin, an aromatic hydrocarbon resin, an aliphatic hydrocarbon resin, a mixed aliphatic/aromatic resin, a terpene resin, a hydrogenated hydrocarbon resin, an alkylphenol resin, a modified phenol-formaldehyde resin, or any combination thereof.

9. The curable composition of claim 1, further comprising at least one of a filler, a dispersant, a light stabilizer, a UV absorber, a pigment, an antioxidant, an adhesion promoter, a moisture scavenger, a defoamer, a rheology modifier, a catalyst, a plasticizer, a wax, a reactive diluent, or any combination thereof.

10. The curable composition of claim 9, wherein the filler comprises calcium carbonate, talc, amorphous silica, magnesium silicate, mica, graphite, white cement, fly ash, titanium oxide, silica fume, bentonite or any combination thereof.

11. The curable composition of claim 9, wherein the at least one dispersant comprises a low molecular weight polymer, a high molecular weight polymer, an oligomer with an anionic functional group, an oligomer with a cationic functional group, an oligomer with a nonionic functional group, or any combination thereof.

12. The curable composition of claim 9, wherein the plasticizer comprises a phthalate, an adipate, an aromatic oil, an aliphatic oil, a naphthalic oil, tri-ethylene glycol, di-ethylene glycol, polyethylene glycol, an organic ester, a low T_{g} oligomer, or any combination thereof.

13. The curable composition of claim 9, wherein the rheology modifier comprises a gum, a cellulosic, an alkali swellable emulsion (ASE), a hydrophobically modified alkali swellable emulsion (HASE), a hydrophobically modified polyurethane (HEUR), a hydrophobically modified polyether (HMPE), an attapulgite, a castor oil, a wax, a urea based thixotrope, an oxidized polyethylene, a polyamide, or any combination thereof.

14. The curable composition of claim 1, wherein the curable composition further comprises a catalyst.

15. The curable composition of claim 14, wherein the catalyst comprises a tin-based catalyst, a bismuth-based catalyst, a zinc-based catalyst, a titanium-based catalyst, or any combination thereof.

16. A method of waterproofing a construction surface, the method comprising:
a. applying a liquid layer of the curable composition according to claim 1 over the construction surface; and
b. allowing the curable composition to cure, to form a solid waterproofing layer.

17. The method of claim 16 further comprising applying a layer of hydratable cementitious composition over the waterproofing layer and hardening the hydratable cementitious composition to form a hardened concrete, wherein a peel adhesion between the hardened concrete and the waterproofing layer is at least 3.0 pounds per linear inch (pli) or 0.525 Newtons per mm according to modified ASTM D903-98 (2017).

18. The method of claim 16, wherein the construction surface comprises a soil-retention structure or a base slab.

19. The method of claim 16, wherein the construction surface further comprises at least one article protruding out of the construction surface, and wherein the step of applying a liquid layer of the curable composition over the construction surface further comprises applying the liquid layer of the curable composition at a base of the at least one article.

20. The method of claim 16, wherein the construction surface further comprises a functional layer disposed over the construction surface, and wherein the step of applying a liquid layer of the curable composition comprises applying the liquid layer of the curable composition over a surface of the barrier layer.

21. The method of claim 20, wherein the functional layer is a film comprising a cured composition, a polymer coating, a polymer based material, a polyolefin, a polyester, a polyurethane, a polystyrene, an acrylic, a styrenic block copolymer, a silicone, ethylene propylene diene monomer, a textile, a foam, a bituminous composite, or any combination thereof.

22. The method of claim 21, wherein the foam comprises a polyolefin, a polyester, a polyurethane, a polystyrene, an acrylic, a styrenic block copolymer, a silicone, a bituminous composite, or any combination thereof.

23. The method of claim 16, wherein the construction surface is selected from among concrete, metal, polyolefin, a polyester, a polyurethane, a polystyrene, polyvinylchloride, an acrylic, a styrenic block copolymer, a silicone, ethylene propylene diene monomer, a textile, a foam, or a bituminous composite, and wherein upon curing, the cured composition exhibits an adhesion of at least 3 pli or 3 to 100 pli, or 3 to 75 pli, or 3 to 60 pli, 3 to 50 pli, or 5-40 pli, according to ASTM D903-98(2017) to the construction surface on which it is applied.

24. A below-grade waterproofing system made according to the method of claim 16.

25. A waterproofing kit comprising a first composition comprising at least one silane-modified polymer; and optionally a second composition comprising at least one latex emulsion with total organic solid in an amount of 5-90 wt %, wherein the first composition and/or the second composition comprise at least one tackifier, a polymeric additive, or a combination thereof in an amount of at least 1 wt %, and wherein the amounts in wt % are based on the total weight of the curable composition.

26. The waterproofing kit of claim 25, wherein the at least one latex emulsion comprises at least one homopolymer, copolymer, or any combination thereof and comprising an acrylate, a styrene acrylate, a silane, a siloxane, a polyvinyl, a carboxylated styrene butadiene, a styrene butadiene, a styrene isoprene, or any combination thereof.

27. The waterproofing kit of claim 25, wherein the first composition comprises the silane-modified polymer and the second composition comprises the at least one latex emulsion.

28. The waterproofing kit of claim 25, wherein the tackifier comprises a hydrogenated gum rosin, a glycerol ester of gum rosin, a pentaerythritol ester of gum rosin, a methyl ester of gum rosin, an aromatic hydrocarbon resin, an aliphatic hydrocarbon resin, a mixed aliphatic/aromatic resin, a terpene resin, a hydrogenated hydrocarbon resin, an alkylphenol resin, a modified phenol-formaldehyde resin, or any combination thereof.

29. The waterproofing kit of claim 25, wherein the first composition, the second composition, or any combination thereof comprises a dispersant.

30. The waterproofing kit of claim 25, wherein the kit further comprises instructions for forming a curable composition by mixing the first composition and the second composition in a volume ratio of from 1:99 to 99:1, and forming a waterproofing layer after curing the curable composition, wherein the waterproofing layer has a Young's modulus (E) of at least 0.05 MPa and not greater than 10 MPa.

31. The waterproofing kit of claim 25, wherein the first composition and/or the second composition further comprises at least one additive selected from a filler, a plasticizer, a rheology modifier, a catalyst, an antioxidant, a UV absorber, a light stabilizer, a defoamer, a moisture scavenger, an adhesion promoter, a wax, a reactive diluent, a polymeric additive, or any combination thereof.

32. A waterproofing article comprising a waterproofing layer disposed over at least a portion of a barrier layer, wherein the waterproofing layer is formed of the cured curable composition according to claim 1, and wherein the barrier layer is configured to provide moisture and/or vapor barrier.

33. The waterproofing article of claim 32, further comprising a particulate layer disposed over at least a portion of the waterproofing layer on a side opposite the barrier layer.

34. The waterproofing article of claim 32, wherein the barrier layer comprises a film or a foam.
